(19) United States
(12) Patent Application Publication
(10) Pub. No.: US 2008/0018122 A1
(43) Pub. Date: Jan. 24, 2008

(54) Rifle Sling and Method of Use Thereof

(76) Inventors: Robert Zierler, Kingston, GA (US); Mark Pasquini, Lawrenceville, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/612,857

(22) Filed: Dec. 19, 2006

Related U.S. Application Data
(60) Provisional application No. 60/754,442, filed on Dec. 28, 2005.

(51) Int. Cl. A47J 45/00

(52) U.S. Cl. 294/1.1

(57) ABSTRACT

A rifle sling having two belts with buckles connected via a ring that can be secured to a hoist line. Two straps are connected to the two belts via the buckles to permit adjustment of the sling. The two straps have wraparound portions at the other ends thereof that are tightened around the stock and barrel of the rifle. Frictional material on the wraparound portions retains the straps in position on the stock and barrel. The angle of the rifle relative to a ground surface is determined by selectively adjusting the length of the straps.

### CROSS-REFERENCE TO RELATED APPLICATIONS

To the fullest extent permitted by law, this non-provisional patent application claims priority to, and the full benefit of, U.S. Provisional Patent Application No. 60/754,442, filed Dec. 28, 2005, entitled “Rifle Sling and Method of Use Thereof”.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a support sling for a firearm, and more specifically to a rifle sling and method of use thereof, wherein the rifle sling enables a rifle to be hoisted vertically to an elevated position such as a hunter's tree stand.

2. Description of Related Art

Firearms are often equipped with slings to facilitate carrying. Such slings are typically secured to the firearm via attachment swivels mounted to the stock at the front and rear thereof. Alternatively, an attachment swivel may be affixed to the barrel in lieu of the front stock. Such slings are typically adjusted to permit transport of the firearm across the back of the user. Unfortunately, such slings do not provide for attachment of a line to hoist a firearm to an elevated location.

Frequently, when hunting, it is necessary for a hunter to climb to such an elevated position, such as onto a tree stand, and a hunter must carry his/her firearm as he/she climbs to the elevated position. When climbing with an elongated firearm, the firearm can easily become snagged on tree limbs or other obstacles. In addition, carrying a firearm while climbing presents a significant hazard should the climber accidentally fall with the firearm strapped to him/her.

A more desirable method of transporting a firearm to an elevated position, such as to a tree stand, is to leave the gun safely on the ground, attach a harness, climb up to the elevated position, and then, utilizing a hoist line secured to the harness, pull the firearm up. This method has the obvious advantages of freeing the climber's hands, until he/she is securely in position, thereby reducing the possibility of dropping the firearm. However, pulling a firearm up through branches of a tree may be difficult, may cause noise that might alert prey, and/or may cause damage to the firearm or the tree. Further, the harness is an additional component that a hunter must transport with him/her in order to have the harness available when needed.

Accordingly, various attempts have been made to facilitate transit of the firearm through a tree. For example, one device comprises a harness that supports a firearm by its scope. The harness comprises two belts that surround the front end and back end of the scope, supporting the rifle. Each belt is fastened by a buckle securely around the scope. The belts are adjustable to support the firearm at a predetermined angle with respect to the ground. A hoist line is subsequently secured to the harness to raise it to a tree stand.

As mentioned above, it is desirable to avoid any noisy attachments, such as the aforementioned sling swivels and metal clips, for both hunting and military weapons. Unfortunately, such sling swivels can make noise that can alert prey to the presence of a hunter or soldier. Further such sling swivels are typically fixed in position and cannot be adjusted.

Additionally, it is common for firearms to have stocks made of expensive, well finished, wood. Owners of such rifles are reluctant to attach a sling with components that could damage the finish of the stock.

Therefore, it is readily apparent that there is a need for a rifle sling that can be utilized to conveniently transport a weapon and function as a support to align the firearm in a fashion to facilitate transit through trees and brush. It is further desirable that such sling/support harness can be readily adjusted and that it refrain from marring fine wood finishes of firearm stocks.

### BRIEF SUMMARY OF THE INVENTION

Briefly described, in a preferred embodiment, the present invention overcomes the above-mentioned disadvantages and meets the recognized need for such a device by providing a rifle sling that permits carrying a firearm across a hunter's back for transport, carrying the firearm in a generally horizontal position of readiness for use, or carrying the firearm in a position for transporting to an elevated position. Because the sling can be utilized for multiple applications, it obviates the need to encumber a hunter/soldier with additional devices.

According to its major aspects and broadly stated, the present invention in its preferred form is a rifle sling and method of use thereof, wherein the rifle sling comprises two belts with buckles connected via a ring, and wherein the ring is adapted to receive a fastener of a hoist line. The present invention includes two straps, wherein one end of each of the two straps is connected to one of the belts via its buckle, thereby to permit adjustment of the sling. The two straps comprise loops at the other end thereof, wherein the buckle end of the straps is passed through the loop to form a wraparound portion at the loop end of the straps, wherein one of the wraparound portions is passed over the butt end of the stock and the wraparound portion is tightened thereto by pulling the buckle end of the strap to reduce the diameter of the wraparound portion, and wherein the other wraparound portion is passed over the muzzle end of the barrel and the wraparound portion is subsequently tightened to the barrel, again by pulling the buckle end of the strap to reduce the diameter of the wraparound portion. Both wraparound portions comprise frictional material to retain them on the stock and barrel.

More specifically, the present invention comprises a rifle sling comprising two straps, two belts and a ring. One end of each of the straps comprises a wraparound portion and a loop end, wherein the wraparound portion passes through the loop end. The wraparound portions have frictional liners dispose thereon to provide retention of the wraparound portion on the stock and/or barrel of the firearm. By feeding the non-loop end of the straps through their corresponding loops, a tightening circumference is formed, whereby placing the tightening circumference around an object, such as, for exemplary purposes only, a rifle stock or rifle barrel, and pulling on the non-loop end will result in tightening of the strap securely around the object.

The two belts are fixedly attached to the ring and each belt has a buckle thereon. The straps engage the buckles, wherein the buckles permit selective adjustment of the lengths of the straps. The straps and/or belts may comprise, for exemplary purposes only, solid materials, such as leather or plastic, or open materials, such as flat or tubular woven webbing or rope.

In use, the rifle sling is secured to a rifle, wherein one of the wraparound portions is passed over the muzzle end of the barrel and the wraparound portion is tightened against the barrel to engage the frictional liner with the barrel. Similarly, the other wraparound portion is passed over the butt end of the stock and is tightened against the stock to engage the frictional liner with the stock. Thus, the instant rifle sling does not require noisy sling swivels and can be readily positioned on the stock and/or barrel by the hunter/soldier.

The rifle may be lifted with the muzzle end upward or with the butt end upward by selectively shortening and lengthening the straps at the buckles. By fastening a hoist line to the ring and pulling upward on the hoist line, the rifle assumes a tilted disposition with the muzzle end or the butt end selectively pointing upward according to the aforementioned selective shortening and/or lengthening of the straps. In such fashion, the rifle can pass easily through the branches of a tree and be transported to a tree stand.

Accordingly, a feature and advantage of the present invention is its ability to facilitate hoisting a firearm to a tree stand.

Another feature and advantage of the present invention is its ability to selectively hoist a firearm with the muzzle end of the barrel first or with the butt end of the stock first.

Still another feature and advantage of the present invention is its ability to be attached to a firearm without the need for mounting noisy fastening attachments to the firearm.

Yet another feature and advantage of the present invention is its ability to be utilized as a firearm sling.

Yet still another feature and advantage of the present invention is its ease of adjustment.

A further feature and advantage of the present invention is its protection against marring of a firearm stock or barrel.

These and other features and advantages of the present invention will become more apparent to one skilled in the art from the following description and claims when read in light of the accompanying drawings.

### BRIEF DESCRIPTION OF THE SEVERAL VIEWS OF THE DRAWING

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a rifle sling according to a preferred embodiment of the present invention;

FIG. 2 is a perspective view of a rifle sling according to a preferred embodiment of the present invention, shown installed on a rifle;

FIG. 3 is a perspective view of a rifle sling according to a preferred embodiment of the present invention, shown holding a rifle in muzzle upward disposition while the rifle is being raised to a tree stand; and

FIG. 4 is a perspective view of a rifle sling according to a preferred embodiment of the present invention, shown holding a rifle in muzzle downward disposition while the rifle is being raised to a tree stand.

### DETAILED DESCRIPTION OF THE PREFERRED AND SELECTED ALTERNATE EMBODIMENTS OF THE INVENTION

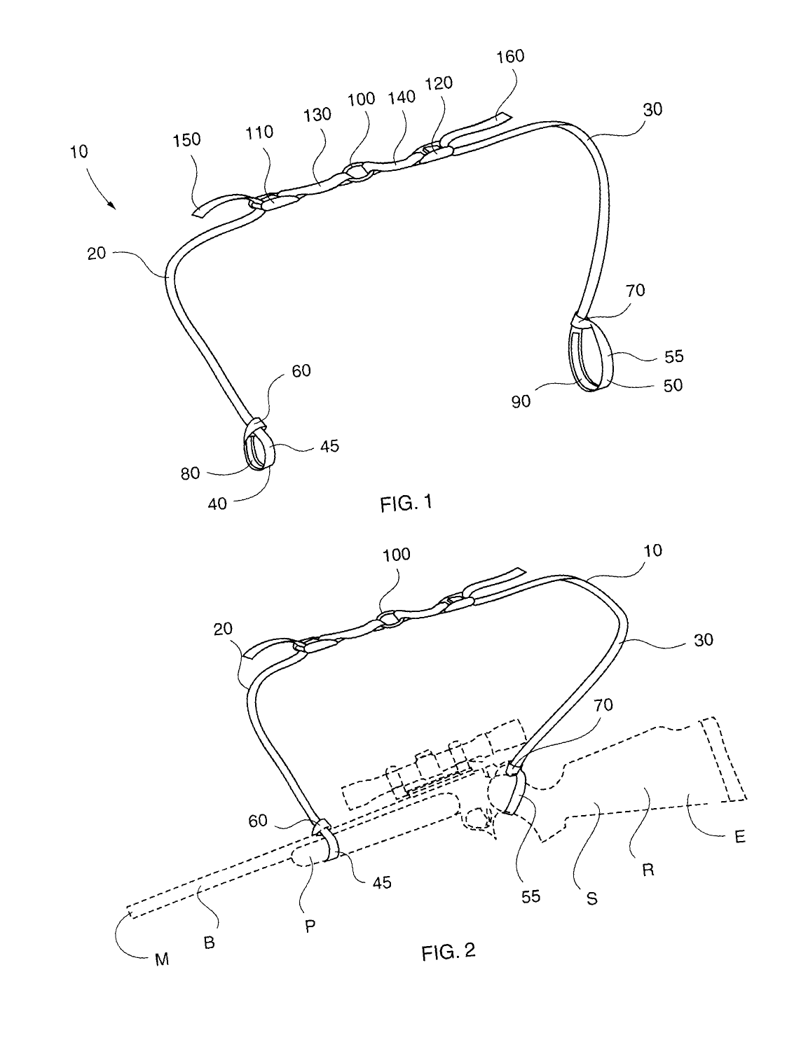

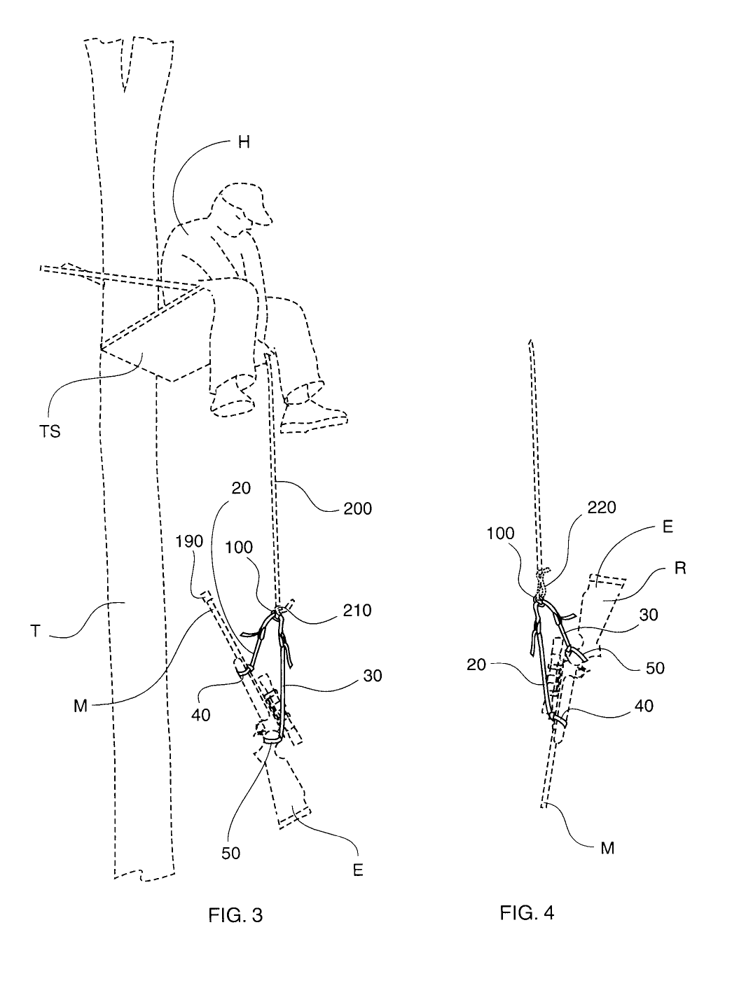

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is a rifle sling and method of use thereof, wherein rifle sling 10 preferably comprises first strap 20, second strap 30, first belt 130, second belt 140 and ring 100. First strap 20 preferably comprises first end 150 and second end 40, wherein second end 40 preferably comprises wraparound portion 45 and loop 60, and wherein wraparound portion 45 preferably passes through loop 60, wherein when loop 60 is disposed over an object, pulling on strap 20 causes wraparound portion 45 to move within loop 60, thereby reducing the dimension of loop 60. Second strap 30 preferably comprises first end 160 and second end 50, wherein second end 50 preferably comprises wraparound portion 55 and loop 70, and wherein wraparound portion 55 preferably passes through loop 70, wherein when loop 70 is disposed over an object, pulling on second strap 30 causes wraparound portion 55 to move within loop 70, thereby reducing the dimension of loop 70.

Wraparound portion 45 preferably has frictional liner 80 disposed thereon and wraparound portion 55 preferably has frictional liner 90 disposed thereon. Frictional liner 80 is preferably shorter than frictional liner 90, wherein frictional liner 80 is of a length suitable to substantially encompass the circumference of barrel B selectively including barrel forearm portion P, and wherein frictional liner 90 is of a length suitable to substantially encompass the circumference of stock S. Frictional liners 80, 90 comprises a frictionally tacky material, such as, for exemplary purposes only, foam rubber, wherein frictional liners 80, 90 removably adhere to barrel B and stock S, respectively. First strap 20, second strap 30, first belt 130 and second belt 140 comprise, for exemplary purposes only, solid materials, such as leather or plastic, or open materials, such as flat or tubular woven webbing or rope.

First belt 130 and second belt 140 are preferably secured to ring 100, wherein first belt 130 preferably comprises buckle 110 and second belt 140 preferably comprises buckle 120. First end 150 of first strap 20 preferably cooperatively engages buckle 110 and first end 160 of second strap 30 preferably cooperatively engages buckle 120, wherein buckles 110 and 120 preferably permit selective adjustment of the lengths of first strap 20 and second strap 30, respectively.

In use, rifle sling 10 is preferably secured to rifle R, wherein first end 40 is preferably passed over muzzle end M of barrel B and wraparound portion 45 is preferably tightened against the barrel B, wherein frictional liner 80 is dimensioned to frictionally engage barrel B, is preferably disposed against barrel B, and preferably secures first strap 20 to rifle R. Similarly, second end 50 is preferably passed over butt end E of stock S, is preferably disposed against stock S, and preferably secures second strap 30 to rifle R. By feeding first ends 150, 160 of straps 20, 30 through their respective loops 60, 70, tightening circumferences comprising wraparound portions 45, 55 are formed, whereby placing the wraparound portions 45, 55 around rifle barrel forearm portion P and rifle stock S, respectively, and pulling on the first ends 150, 160, will result in tightening of straps 20, 30 securely around rifle barrel forearm portion P and rifle stock S respectively.

To raise rifle R with muzzle end M aligned upward and butt end E aligned downward in a near vertical aspect, first strap 20 is preferably shortened and secured by buckle 110 and second strap 30 is preferably lengthened and secured by buckle 120. Subsequently, fastener 210 of hoist line 200 is preferably secured to ring 100, wherein fastener 210 preferably comprises a knot, a clip, carabiner 220 or the like. Upon hoisting rifle R upward by pulling on hoistline 200, rifle R preferably assumes a balanced tilted disposition with muzzle end M pointing upward. In such fashion, rifle R can pass easily through branches of tree T and be transported to three stand TS.

Should hunter H desire to hoist rifle R with butt end E of stock S aligned upward in a near vertical aspect, first strap 20 is preferably lengthened and secured by buckle 110 and second strap 30 is preferably shortened and secured by buckle 120. Upon attachment of fastener 210 to ring 100 and raising of hoist line 200, rifle R preferably assumes a balanced disposition with butt end E of stock S pointing upward.

Cap 190 can selectively be placed over muzzle end M of barrel B to prevent dirt and other debris from entering barrel B and fouling same. A second fastener (not shown) may be utilized on hoist line 200 for temporary fastening to clothing, apparel or other gear of hunter H, thus rendering hunter H's hand free for use in climbing and not requiring hand retention of hoist line 200 and/or rifle R while climbing.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A rifle sling comprising:
at least one strap, wherein said strap comprises wraparound ends; and
frictional material disposed at said wraparound ends of said at least one strap.

2. The rifle sling of claim 1, wherein said at least one strap comprises a barrel strap and a stock strap.

3. The rifle sling of claim 2, wherein said frictional material is disposed on said barrel strap and said stock strap, and wherein said frictional material on said barrel strap is shorter than said frictional material on said stock strap.

4. The rifle sling of claim 2, wherein said wraparound end of said barrel strap is dimensioned to frictionally engage a rifle barrel, and wherein said wraparound end of said stock strap is dimensioned to frictionally engaged a rifle stock.

5. The rifle sling of claim 2, wherein said straps are connected to a ring, and wherein said ring comprises an attachment point for balanced lifting of the firearm.

6. The rifle sling of claim 2, wherein said straps comprise belt adjustment, and wherein said belt adjustment facilitates selective lengthening and shortening of said straps.

7. The rifle sling of claim 2, wherein said straps further comprise frictionally tacky material disposed thereon.

8. The rifle sling of claim 7, wherein said frictionally tacky material comprises foam rubber.

9. A method of raising a rifle, said method comprising the steps of:
frictionally holding a portion of a rifle stock;
frictionally holding a portion of a rifle barrel; and,
adjusting a support position between said two frictionally-held portions.

10. The method of claim 9, wherein said step of adjusting further comprises the step of:
lengthening a first strap and shortening a second strap, wherein said lengthening and shortening aligns the rifle in a near vertical aspect.

11. The method of claim 10, wherein the rifle comprises a muzzle end, and wherein said step of lengthening and shortening further comprises the step of:
aligning the muzzle end of the rifle upward.

12. The method of claim 10, wherein the rifle comprises a butt end of a stock, and wherein said step of lengthening and shortening further comprises the step of:
aligning the butt end of the stock of the rifle upward.

13. The method of claim 9, wherein said steps of frictionally holding comprise frictionally holding said portions via straps having frictional material disposed at wraparound ends thereof.

14. The method of claim 11, further comprising the step of:
installing a cap over the muzzle end of the barrel.

15. The method of claim 13, further comprising the step of:
utilizing said straps as a sling for the rifle.

16. A system for hoisting a firearm comprising:
a rifle; and
a rifle sling having straps comprising frictional material disposed at wraparound ends of said straps.

17. The system for hoisting of claim 16, wherein said straps are connected to a ring, and wherein said ring comprises an attachment point for lifting said rifle.

18. The system for hoisting of claim 16, wherein said straps comprise belt adjustment, and wherein said belt adjustment facilitates selective lengthening and shortening of said straps.

19. The system for hoisting of claim 16, wherein said straps further comprise frictionally tacky material.

20. The system for hoisting of claim 19, wherein said frictionally tacky material comprises foam rubber.
